(19) United States
(12) Patent Application Publication
(10) Pub. No.: US 2012/0000059 A1
(43) Pub. Date: Jan. 5, 2012

(54) Object Connector

(76) Inventors: Nathaniel Fox, Westport, CT (US); Michael Lo, Stamford, CT (US)

(21) Appl. No.: 13/176,296

(22) Filed: Jul. 5, 2011

Related U.S. Application Data
(60) Provisional application No. 61/361,392, filed on Jul. 3, 2010.

(51) Int. Cl. F16B 17/00; B23P 11/00

(52) U.S. Cl. 29/525.01; 403/375

(57) ABSTRACT

An object connector is described to include at least one arm and at least one slot. The arm of the object connector includes a channel for gripping an object. The slot of the object connector includes at least one undulating side designed to receive another object connector. The object connector can include more than one arm or more than one slot. The object connector described herein can be used with both common household objects and specially designed objects to build desired structures or assemblies. The object connector described herein can be made of many different materials depending upon the purpose the object connector is designed for, which includes entertainment, industrial application, household use, etc.

### PRIORITY CLAIM

This application claims priority from U.S. Provisional Patent Application 61/361,392 filed Jul. 3, 2010, which is incorporated herein by reference.

### BACKGROUND

Existing object connectors are usually designed specifically for one type of objects. Often the connectors and the specific objects for which the connectors are designed for are sold or marketed together as a closed kit or building system. This approach has two disadvantages. First, to a new user, all of the pieces in the system are foreign, so the user must learn how each piece of the system works. Second, a user is limited to the specific pieces the user has purchased. Most likely, the object connectors the user has purchased cannot be used on objects with a slightly different shape.

Fasteners may be used to hold objects together. However, fasteners have disadvantages as well. Some fasteners, such as screws and nails, destructively modify the objects they are designed to hold. Other fasteners, such as clamps, are too bulky and expensive to be used as object connectors in a construction project where many objects are needed to be assembled together.

### SUMMARY

The invention relates to a device used to connect objects and methods for making and using the device. The device may be used in many applications including, but not limited to, artistic structures, construction toys, storage, and organization.

In some embodiments, an object connector is disclosed as comprising at least one arm that includes a channel for engaging an object and at least one slot for interconnecting a second object connector. The slot of the object connector has undulating sides with at least one protrusion and is designed to receive a second object connector through the slot of the second object connector. The undulating sides of the slots of the object connector are designed to be in contact with the other object connector when both object connectors are connected.

In some embodiments, an object connector assembly is also disclosed to include a first object connector that has at least one arm with a channel for gripping an object and at least one slot, and a second object connector having at least one arm with a channel for gripping an object and at least one slot. To form an object connector assembly, the second object connector is inserted into the at least one slot of the first object connector through the at least one slot of the second object connector.

An example method of building an object assembly using object connectors is also disclosed. The object connectors have two or more arms with a channel in each arm for gripping an object and at least one slot for inter-connecting with another object connector. The method includes the following steps in building an assembly of objects. First, a first object is inserted into the channel of a first arm of a first object connector. Second, a second object connector is then attached to the assembly by inserting the first object into the channel of a first arm of the second object connector. Third, the assembly can be extended by engaging a third object connector into the slot of the first object connector through the slot of the third object connector.

### BRIEF DESCRIPTION OF THE DRAWINGS

FIG. 1 shows an example embodiment of an object connector with three arms.

FIG. 2A shows a plan view of the embodiment in FIG. 1.

FIG. 2B shows a plan view of an example embodiment of an object connector with four arms.

FIG. 2C shows a plan view of an example embodiment of an object connector with five arms.

FIG. 3 shows a plan view of a second example embodiment of an object connector with four arms.

FIG. 4 shows a plan view of an example embodiment of an object connector without a slot.

FIG. 5 shows an example embodiment of a channel for an object connector.

FIG. 6A shows two object connectors before the object connectors are assembled together.

FIG. 6B shows an example positioning of two object connectors partly assembled together.

FIG. 6C shows an example positioning of two object connectors completely assembled together.

FIG. 6D shows a second example positioning of two object connectors completely assembled together.

FIG. 7 shows an example of using multiple object connectors individually to hold objects together in a rectangular form.

FIG. 8 shows an example of using two object connectors assembled together to hold objects together.

FIG. 9 shows an example of using multiple object connectors to hold objects together.

FIG. 10 shows an example of using all of the arms of an object connector to hold objects.

FIG. 11A shows an example of a castle built using a set of object connectors and playing cards.

FIG. 11B shows a top view of the castle in FIG. 11A.

In the attached drawings, like reference numerals designate corresponding similar parts. The features of the illustrated embodiments can generally be combined unless they clearly exclude each other. Example embodiments are depicted in the drawings and are detailed in the description that follows.

### DETAILED DESCRIPTION

The present application discloses a non-destructive object connector that is versatile and can be used to connect both commonly found objects and objects of rare shapes. In addition, the object connector disclosed herein is inexpensive, compact, easy to store, and can be assembled with other object connectors to build different types of desired structures.

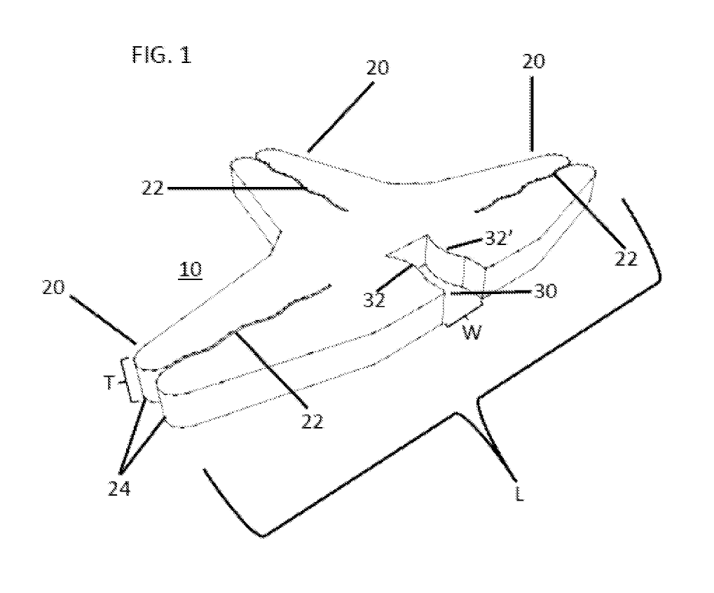

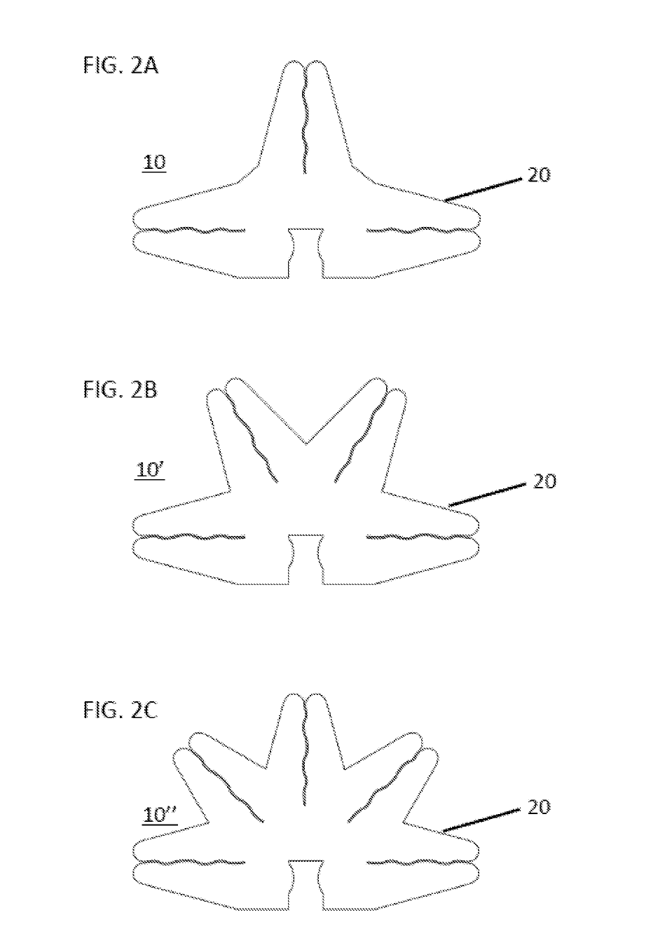

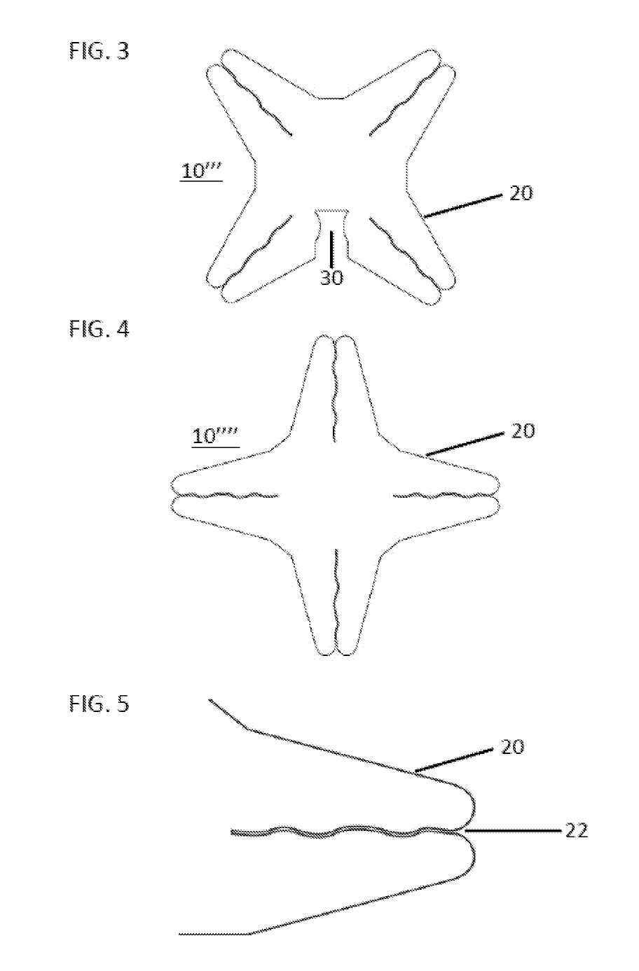

As shown in the embodiments depicted in FIGS. 1-11B, an object connector includes one or more arms, each arm having a channel for holding an object. FIG. 1 is an embodiment of an object connector 10 with three arms 20. The object connector 10 may have one or more arms 20. For example, the object connector 20 may have three arms as illustrated in FIGS. 1 and 2A; four arms as illustrated in FIGS. 2B, 3, and 4; or five arms as illustrated in FIG. 2C. While the arms 20 of the object connectors 10, 10′ and 10″ in FIGS. 2A-2C are illustrated as being equally spaced within about 180°, other example embodiments of the object connector 10 may have the arms spread out over a range that is greater than 180°, as illustrated in FIGS. 3 and 4, or over a range that is less than 180°. In addition, the arms 20 may be unevenly spaced so that some adjoining arms are closer to each other than other adjoining arms. Furthermore, the arms 20 of an object connector 10 may be of different lengths and different shapes and thicknesses.

As shown in FIG. 1, each arm 20 has a channel 22 for gripping objects. As illustrated in FIG. 5, the channel 22 has an undulating profile. The protrusions that alternate along the length of the channel 22 create a pinching effect to grip an object placed in the channel 22. The channel width is sized so that an object placed in the channel 22 will experience frictional forces. The stronger the frictional force, the more tightly the object will be held in the channel 22. The width of the channel 22 may be selected so that it does not exceed the amplitude of the undulating profile of the object plus the thickness of the object intended to be held by the channel 22. This constraint may be applied to the entire length of channel 22 or to one or more sections along the length of channel 22. The channel 22 may have a constant width along its length. Alternatively, the channel 22 may have varying width along its length. For example, the width of the channel 22 may include a taper along a portion of its length.

In FIG. 1, each arm 20 of the example embodiment of the object connector 10 has two ends 24 that taper into the channel 22. The tapered design of the ends 24 guides the edge of the object to be held into the channel 22, making the process of attaching the object to the object connector 10 easier. One of ordinary skill in the art will appreciate that many geometries are possible for the arm 20. For example, as illustrated in the figures throughout, the arm 20 may become wider near the center of the object connector 10. This triangular profile for the arm 20 reduces the amount of material needed to achieve a certain level of durability.

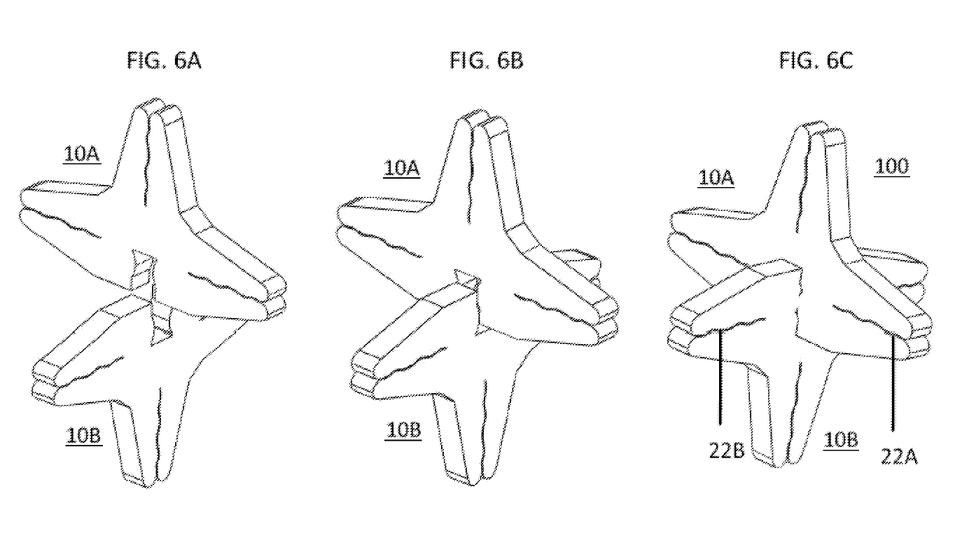

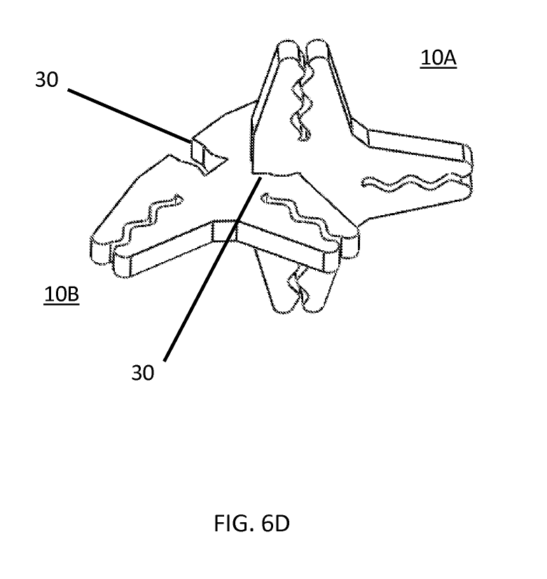

The object connector 10 in FIG. 1 includes a slot 30 for assembling multiple object connectors 10 together. In some embodiments, the slot 30 includes a pinching region formed between a first protrusion 32 on a first inner side of slot 30 and a second protrusion 32′ on a second inner side of slot 30, where the first protrusion 32 may be positioned approximately opposite to the second protrusion 32′. The width W of slot 30 can be designed to depend upon the thickness T of the object connector 10 and may be designed to be approximately the same as the thickness T of the object connector 10. The profiles of protrusions 32 and 32′ may include, but are not limited to, a single portion of a circle, multiple portions of a circle, or undulating teeth or ridges. The positions of the protrusions 32, 32′ on the inner sides of slot 30 can be varied to allow two object connectors to be assembled differently. In the embodiments illustrated in FIG. 6C, the protrusions 32, 32′ may be positioned such that when two object connectors 10A, 10B are assembled together, the planes through the channels 22A, 22B are not offset (zero planar offset). Alternatively, the protrusions 32, 32′ may be positioned such that when two object connectors 10A, 10B are assembled together, the planes through the channels 22A and 22B have a nonzero offset, i.e., the channels 22A and 22B are not in the same plane. In addition, the protrusions may be positioned such that when two object connectors, 10A and 10B, are assembled together, the peaks of the protrusions 32, 32′ on the first object connector 10A are positioned past the peaks of the protrusions 32, 32′ of object connector 10B, and vice versa. Yet in another embodiment as illustrated in FIG. 6D, the protrusions of the object connector 10A are configured to allow the first object connector to snap over the edge of the object connector 10B.

In some embodiments, an object connector 10 may include magnets in the sides of the slot 30 such that when two object connectors are assembled together, the magnetic forces hold the object connectors together. Alternatively, in the embodiment illustrated in FIG. 4, the object connector 10″″ may have no slot 30.

In the embodiments shown in FIGS. 6A-6C, the slots 30 in object connectors 10 allow two planar object connectors 10A, 10B to be assembled into a combined object connector 100. FIG. 6A shows two object connectors 10A, 10B in position before being assembled together. FIG. 6B shows the two object connectors 10A, 10B partially assembled together. FIG. 6C shows the two object connectors 10A, 10B completely assembled together, forming a combined object connector 100. The combined object connector 100 enables a user to hold objects in more orientations, thus increasing the number of ways in which objects may be positioned with respect to each other and increasing the number of objects that can be held in one location. Object connectors 10A, 10B may be designed so that the opposing channels 22A and 22B on the two connected object connectors 10A, 10B meet on approximately the same plane so that an object may be inserted into opposing channels 22A and 22B to gain additional support for the overall structure.

FIG. 6D illustrates another example of a combined object connector 200. In FIG. 6D, the combined object connector 200 is formed by inserting an object connector 10B into the slot of an object connector 10A. The object connector 10A clips onto the object connector 10B in between two arms. However, the two object connectors 10A and 10B are connected not through the slot of the object connector 10B, unlike the two object connectors shown in FIG. 6C.

The object connector 10 may hold any object with an edge that can be gripped by the channel 22 of an arm 20. For example, the object connector 10 may be used to build structures out of planar objects, such as paper products, cardboard, playing cards, acrylic sheets, plastic sheets, cardstock, and photographic paper. The object connector 10 may also be used to build structures out of non-planar objects with an edge or area that can be inserted into the channel 22, for example, paper plates, balloons, or folded planar objects such as origami.

The design of the object connector 10 may depend on the size and weight of the object to be held. The object connector 10 may be sized differently for different objects. Alternatively, the object connector 10 may be designed as a universal object connector that can hold different common household objects. In addition, the desired durability and aesthetics of the object connector 10 may affect its design. For example, the object connector 10 may be designed for use with common household items. Such object connector 10 may be sized to be suitable for use with paper or paper-like products between about 1/25th of an inch and 1/200th of an inch. Many business cards, index cards, playing cards, greeting cards, and plastic sheets fall within this category of products. In referring to FIG. 1, an example embodiment of such an object connector 10 may have a thickness T between about 1/32 of an inch and about ¼ of an inch, depending on the material used, the desired gripping power, and the desired durability of the object connector.

The width of the channel 22 affects the gripping power of the object connector 10 and can be designed based on the desired gripping power. The width of the channel 22 may also be affected by manufacturing constraints. Preferably, the width of the channel 22 may be designed to be smaller than the amplitude of the undulating profile of the object plus the thickness of the object intended to be held. For example, the width of the channel 22 produced by a laser cutter in acrylic may be approximately 1/100 of an inch.

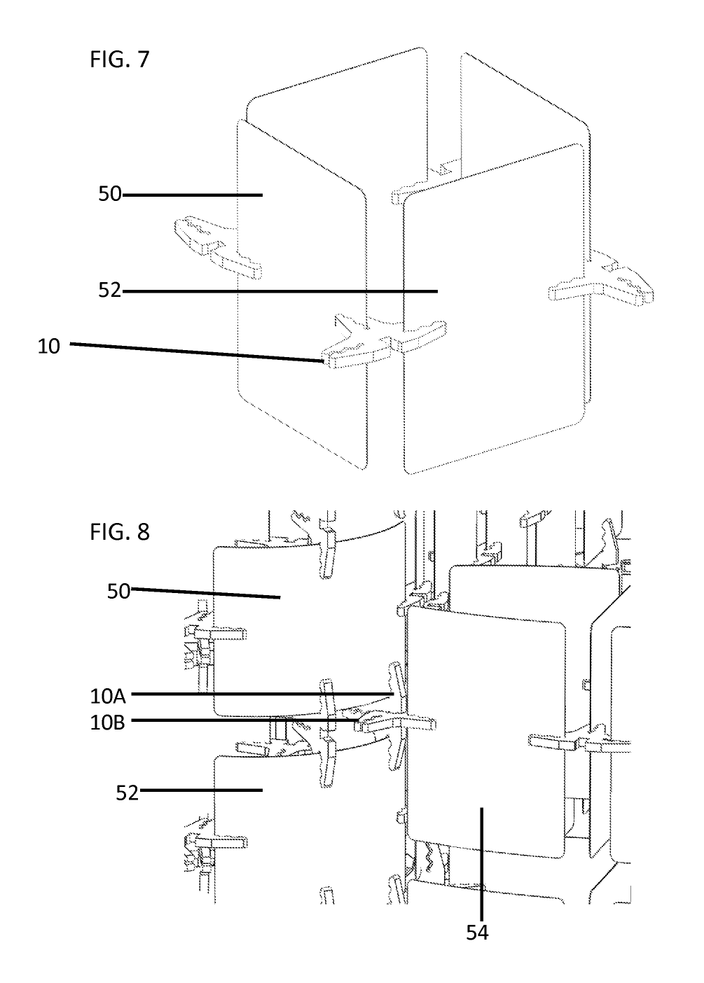

The length of the channel 22 also affects the gripping power. A longer channel provides more gripping power than a shorter channel. For example, a length of 0.4 inches may be used for the channel 22. In referring to FIG. 1, the slot 30 may have a width W of approximately the thickness T of the object connector 10 with a margin of 0.1 inch. The overall length L of the object connector 10 depends on the length of the channel 22 and the width of the slot 30, and other factors such as aesthetic considerations. The overall length L may be between, for example, approximately 1.2 inches and 1.5 inches. It will be apparent to those of skill in the art that the dimensions or measurements provided herein are for illustrative purposes only. Other design specifications may be chosen without departing from the spirit and scope of the invention. The object connector 10 may be used to form many different types of structures. For example, as illustrated in FIG. 7, an object connector 10 may be used to hold a first object 50 and a second object 52 at a right angle to each other. Repeated use of this pattern forms a rectangular structure of the objects.

As illustrated in FIG. 8, two object connectors 10A, 10B may be assembled to form a combined object connector 100 using the process shown in FIGS. 6A-6C. The first object connector 10A may be used to hold a first object 50 and a second object 52 in a first orientation. The second object connector 10B may be used to hold a third object 54 in a second orientation orthogonal to the first orientation.

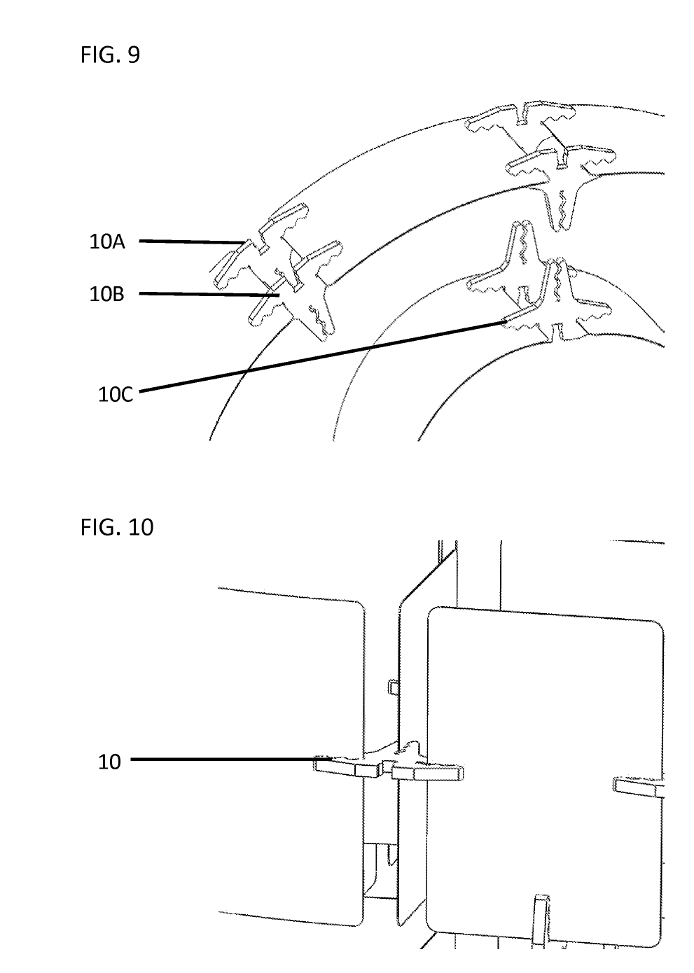

As illustrated in FIG. 9, more than one object connector 10 may be used to hold objects together. For example, the object connectors 10A and 10B may be used to hold two objects in an arc. The unused arms 20 of the object connectors 10A and 10B are pointed towards the inside of the arc. However, the unused arm 20 may also be pointed towards the outside of the arc, as shown by object connector 10C.

As illustrated in FIG. 10, every arm 20 of object connector 10 may be used, depending on the requirements of the desired structure to be built.

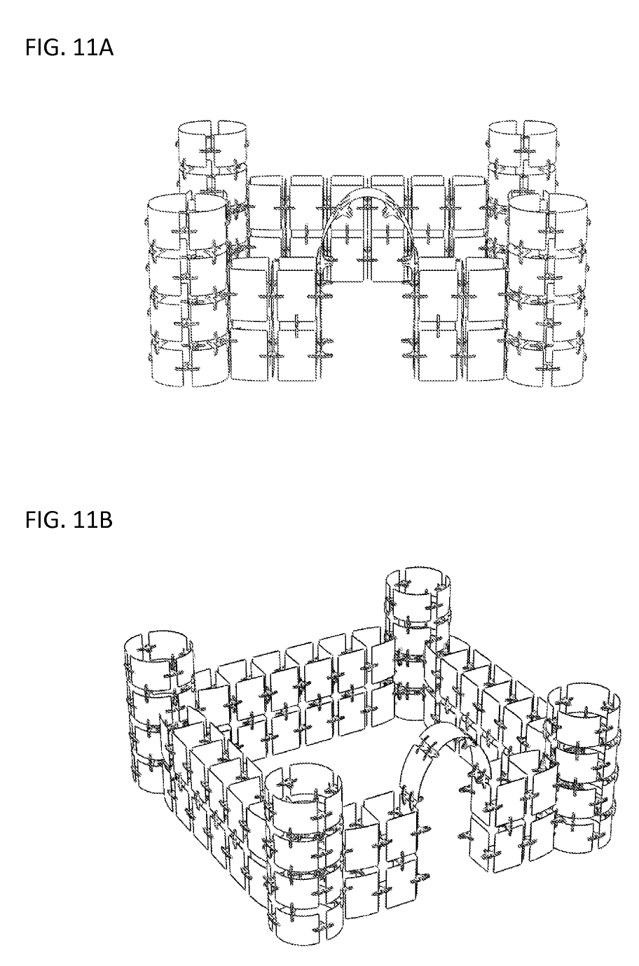

FIGS. 11A and 11B show an example structure, a castle, built out of object connectors and playing cards. FIG. 11A shows a front view of the castle and FIG. 11B shows a top view of the castle. Although many of the examples show the object connector being used with playing cards, one of ordinary skill in the art would understand that the object connector may be used with other objects as well.

The object connector 10 may hold more than one object in the channel 22. For example, an example object connector 10 designed to hold playing cards may have a channel 22 that can hold, one, two, three, or four playing cards. Thus, the channel 22 may be used to hold two ends of a single playing card, or the ends of multiple playing cards. The object connector 10 may be made from many types of materials, depending on the object the object connector 10 is designed to hold. Possible materials include, but are not limited to, metal, acrylonitrile butadiene styrene (ABS), acrylic, polypropylene, polyoxymethylene (e.g., Delrin®), card-stock, and any form of polyethylene, polycarbonate, polyvinyl chloride, polyether ether ketone, and nylon.

The object connector 10 may also be made from more than one material. For example, the protrusions of slot 30 or the inner surfaces of channel 22 may be made from or coated with a material different from the material used for the rest of the object connector 10 to improve the gripping capability of slot 30 and channel 22.

The object connector 10 may be manufactured by creating an extruded profile of the connector and then slicing the extruded profile into the desired connector thickness. The object connector 10 may also be manufactured by laser cutting the object connector 10 profile into sheets of material, such as plastics or a vegetable fiber web like card-stock. The object connector 10 may also be manufactured by the process of injection molding.

The object connector 10 may be used in many applications. For example, it may be used to create sculptures or other structures out of playing cards, credit cards, card stock, and/or other objects. It may also be used to change the presentation of some planar material into a more aesthetic form. It may also be used with objects made from sturdier materials, such as cardboard, balsa wood, and fiberboard, to form shelves, bins, and partitions.

The object connector 10 has many qualities that make it suitable for use as, for example, a construction toy. The object connector 10 is designed to be durable and can be used with many types of household objects. This allows users to be imaginative in what materials to use in their structure. The object connector 10 is easy to use, compact, and inexpensive to manufacture, therefore affordable to many.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit and scope of the invention.

Although the object connector is described with reference to the example embodiments illustrated in the figures, it should be understood that the object connector may be embodied in many alternative forms. One of ordinary skill in the art will additionally appreciate different ways to alter the parameters of the embodiments disclosed, such as the size, shape, elements, or materials, without departing from the spirit and scope of the object connector.

What is claimed is:

1. A first object connector comprising:
at least one arm, the at least one arm comprising at least one channel for engaging an object; and
at least one slot for interconnecting a second object connector, the at least one slot having at least one undulating side with at least one protrusion;
wherein the slot of the first object connector is designed to receive the second object connector through the slot of the second object connector, and the undulating sides of the slot of the first object connector are designed to be in contact with the second object connector.

2. The first object connector of claim 1, wherein the undulating sides of the at least one slot of the first object connector form at least one gripping section, the width of which is narrower than the width of the rest section of the slot.

3. The first object connector of claim 1, further comprising one or more arms, each arm comprising a channel for engaging an object.

4. The first object connector of claim 3, wherein the two or more arms are spaced apart angularly.

5. The first object connector of claim 4, wherein the two or more arms are spaced apart uniformly.

6. The first object connector of claim 1, wherein the channel in the at least one arm has an undulating shape.

7. The first object connector of claim 6, wherein the channel in the at least one arm has varying width along its length.

8. The first object connector of claim 7, wherein the channel in the at least one arm has a taper along a portion of its length.

9. The first object connector of claim 8, wherein the end of the channel in the at least one arm is tapered.

10. The first object connector of claim 1, wherein the general shape of the first object connector is planar and the thickness of the first object connector is approximately the same as the width of the at least one slot of the first object connector.

11. The first object connector of claim 1, wherein the first object connector is constructed using one or more of:
metal,
acrylonitrile butadiene styrene,
acrylic,
prolypropylene,
card-stock, and
any form of Polyethylene, Polycarbonate, Polyvinyl Chloride, Polyether
Ether Ketone, and Nylon.

12. An object connector assembly, comprising:
a first object connector, said first object connector having at least one arm with a channel for gripping an object, and at least one slot; and
a second object connector, said second object connector having at least one arm with a channel for gripping an object, and at least one slot;
wherein the second object connector is inserted into the at least one slot of the first object connector through the at least one slot of the second object connector.

13. The object connector assembly of claim 12, wherein the at least one slot of the first object connector or the at least one slot of the second object connector has at least one undulating side with at least one protrusion for firm engagement between the first object connector and the second object connector.

14. The object connector assembly of claim 12, wherein the first object connector and the second object connector are positioned perpendicularly to each other.

15. The object connector assembly of claim 12, wherein the channel in the at least one arm of the first object connector and the channel in the at least one arm of the second object connector have a non-zero planar-offset.

16. A method of building an assembly of a plurality of objects using a plurality of object connectors, said object connector having two or more arms with a channel in each arm for gripping an object and at least one slot for inter-connecting with another object connector, said method comprising:
inserting a first object into the channel of a first arm of a first object connector;
attaching a second object connector by inserting the first object into the channel of a first arm of the second object connector; and
extending the assembly of objecting by engaging a third object connector into the at least one slot of the first object connector through the at least one slot of the third object connector.

17. The method of claim 16, further comprising extending the assembly of objects by inserting a second object into the channel of a first arm of the third object connector.
